(19) United States
(12) Patent Application Publication
(10) Pub. No.: US 2006/0248456 A1
(43) Pub. Date: Nov. 2, 2006

(54) ASSIGNING A PUBLICATION DATE FOR AT LEAST ONE ELECTRONIC DOCUMENT

(75) Inventors: Todd R. Bender, San Jose, CA (US); Keiko Kurita, Los Gatos, CA (US); Tram T. Nguyen, San Jose, CA (US); C. Wayne Niblack, San Jose, CA (US); Zengyan Zhang, San Jose, CA (US)

Correspondence Address: INTERNATIONAL BUSINESS MACHINES CORPORATION;INTELLECTUAL PROPERTY LAW, 650 HARRY ROAD, SAN JOSE, CA, 95120, US

(73) Assignee: IBM CORPORATION, Armonk, NY (US)

(21) Appl. No.: 10/908,215

(22) Filed: May 2, 2005

(51) Int. Cl. G06F 17/24

(52) U.S. Cl. 715/531

(57) ABSTRACT

The present invention provides a method and system of assigning a publication date for at least one electronic document, where the publication date includes the year that the document was published, the month that the document was published, and the day that the document was published. In an exemplary embodiment, the method and system include (1) recognizing the publication date in the document by regular expression pattern matching, (2) if the publication date is ambiguous, resolving the ambiguous publication date, and (3) validating the publication date. In an exemplary embodiment, the recognizing includes determining at least one candidate publication date from the document identifier of the document. In an exemplary embodiment, the recognizing includes determining the publication date from the textual content of the document. In an exemplary embodiment, the recognizing includes determining the publication date from the metadata of the document.

### FIELD OF THE INVENTION

The present invention relates to electronic documents, and particularly relates to a method and system of assigning a publication date for at least one electronic document.

### BACKGROUND OF THE INVENTION

Programmatically assigning publication dates, or posting dates, for electronic documents in a large, hierarchical, linked collection, where the electronic documents contain both unstructured text and associated metadata that may include date information is challenging. For example, the electronic documents may be Web pages. A date associated with a Web page is not easily discerned programmatically due to the unstructured format and the frequent modifications of Web pages.

1. Need for Assigning Publication Dates

The publication date associated with an electronic document is essential (1) to develop the trending of the subject matter of the electronic document and (2) to understand the context in which the electronic document was written. The publication date of an electronic document provides a reader of the electronic document with an indication of the currency of the content in the electronic document.

2. Challenge of Assigning Dates

An assigned date for an electronic document could be (a) the date when the electronic document was posted on a Web site, (b) the date when the content of the electronic document was written by the author, or (c) the “street date” of the publication (i.e. when the publication actually is first made available in paper form).

Even for electronic documents where dates can be assigned, date formats are not standardized and vary among (a) electronic documents, (b) sources of the electronic documents (i.e. Web sites), and (c) country sources. In addition, different types of dates (e.g. expiration dates, historical dates) may occur in electronic documents.

In addition, all-numeric date patterns may be ambiguous. A common form of ambiguous date pattern is a date pattern in which the month and day may be interchanged (i.e. it is not clear if the date is of the form mmddyy or ddmmyy (such as 09/08/04)). Other language-specific complexities exist as well. For example, in Japanese, there may be ambiguity with the year as well (e.g., “12.11.10” may be December 11, 1910 or Heisei Year 10 (1998), November 10).

3. Prior Art Systems

Currently, prior art methods and systems of assigning a publication date to at least one electronic document fail to address this need. In a first prior art system, as shown in prior art FIG. 1, first prior art publication date assigning system determines the

publication date of an electronic document from the metadata of the document. Therefore, method and system of assigning a publication date for at least one electronic document is needed.

### SUMMARY OF THE INVENTION

The present invention provides a method and system of assigning a publication date for at least one electronic document, where the publication date includes the year that the document was published, the month that the document was published, and the day that the document was published. In an exemplary embodiment, the method and system include (1) recognizing the publication date in the document by regular expression pattern matching, (2) if the publication date is ambiguous, resolving the ambiguous publication date, and (3) validating the publication date.

In an exemplary embodiment, the recognizing includes determining at least one candidate publication date from the document identifier of the document. In an exemplary embodiment, the determining includes (1) if only one candidate publication date is determined and the candidate publication date comprises a year, a month, and a day, assigning the candidate publication date as the publication date for the document, (2) if more than one candidate publication date is determined and if each of the more than one candidate publication date comprises a year, a month, and a day, assigning the most recent candidate publication date as the publication date for the document, and (3) if the candidate publication date specifies only a month and a year, (a) scanning the textual content of the document for a date whose month and year are the same as the month and year of the candidate publication date, (b) if a scanned date whose month and year are the same as the month and year of the candidate publication date is found, assigning the scanned date as the publication date for the document, and (c) if a scanned date whose month and year are the same as the month and year of the candidate publication date is not found, assigning an arbitrary day for the publication date for the document.

In an exemplary embodiment, the recognizing includes determining the publication date from the textual content of the document. In an exemplary embodiment, the determining includes assigning the first date in the textual content as the publication date for the document. In an exemplary embodiment, the recognizing includes determining the publication date from the metadata of the document. In an exemplary embodiment, the determining includes, if the document is a static Web page and if the HTTP Last Modified date is present in the document, assigning the HTTP Last Modified date as the publication date for the document.

In an exemplary embodiment, the recognizing includes, for the regular expression pattern matching, using date patterns defined to support dates specified with textual month names. In an exemplary embodiment, the recognizing includes, for the regular expression pattern matching, using date patterns defined to support dates specified with numeric patterns.

In an exemplary embodiment, the resolving includes, if the publication date has an unambiguous date pattern, using the unambiguous date pattern in the regular expression pattern matching. In an exemplary embodiment, the resolving includes, if the document is fetched repeatedly and if the publication date has an ambiguous date pattern, (1) saving the publication date, (2) if the document is re-fetched and if the date pattern of the saved publication date matches the date pattern of the publication date of the re-fetched document, determining the portion of the publication date that has changed, (3) comparing the determined portion to the time period during which the document was re-fetched, (4) based on the comparing, determining the date pattern for the document, and (5) using the determined date pattern in the regular expression pattern matching.

In an exemplary embodiment, the resolving includes (1) tracking within a hierarchy of electronic documents the locations of the electronic documents having unambiguous date patterns and (2) if the publication date has an ambiguous date pattern, using the unambiguous date pattern associated with the tracked location of the document in the regular expression pattern matching. In an exemplary embodiment, the resolving includes, if the publication date has an ambiguous date pattern, (1) scanning the document for a month name corresponding to publication date and (2) using a date pattern that conforms to the scanned month name and the publication date in the regular expression pattern matching.

In an exemplary embodiment, the resolving includes, if the publication date has an ambiguous date pattern, (1) maintaining a list of default date patterns for a plurality of countries of origin of electronic documents and (2) if the country of origin of the document is determined and is in the list, using the default date pattern for the country of origin in the regular expression pattern matching.

In an exemplary embodiment, the validating includes characterizing the publication date as a valid publication date if the day of the publication date is between 1 and 31, the month of the publication date is between 1 and 12, and the publication date is not more than a specified number of days in the future. In an exemplary embodiment, the beginning of the specific number of days is the HTTP Last Modified date of the document. In an exemplary embodiment, the beginning of the specific number of days is the date that the document was obtained. In an exemplary embodiment, the specific number of days ranges from 1 day to 10 days.

In an exemplary embodiment, the recognizing includes (1) determining at least one candidate publication date from the document identifier of the document, (2) if the determining is unsuccessful, identifying the publication date from the textual content of the document, and (3) if the identifying is unsuccessful, noting the publication date from the metadata of the document. In an exemplary embodiment, the determining includes (1) if only one candidate publication date is determined and the candidate publication date comprises a year, a month, and a day, assigning the candidate publication date as the publication date for the document, (2) if more than one candidate publication date is determined and if each of the more than one candidate publication date comprises a year, a month, and a day, assigning the most recent candidate publication date as the publication date for the document, and (3) if the candidate publication date specifies only a month and a year, (a) scanning the textual content of the document for a date whose month and year are the same as the month and year of the candidate publication date, (b) if a scanned date whose month and year are the same as the month and year of the candidate publication date is found, assigning the scanned date as the publication date for the document, and (c) if a scanned date whose month and year are the same as the month and year of the candidate publication date is not found, assigning an arbitrary day for the publication date for the document.

In an exemplary embodiment, the identifying includes assigning the first date in the textual content as the publication date for the document. In an exemplary embodiment, the noting includes, if the document is a static Web page and if the HTTP Last Modified date is present in the document, assigning the HTTP Last Modified date as the publication date for the document.

The present invention also provides a method and system of assigning a publication date for at least one electronic document, where the publication date includes the year that the document was published and the month that the document was published. In an exemplary embodiment, the method and system include (1) recognizing the publication date in the document by regular expression pattern matching, (2) if the publication date is ambiguous, resolving the ambiguous publication date, and (3) validating the publication date.

In an exemplary embodiment, the recognizing includes determining at least one candidate publication date from the document identifier of the document. In an exemplary embodiment, the determining includes (1) if only one candidate publication date is determined, assigning the candidate publication date as the publication date for the document and (2) if more than one candidate publication date is determined, assigning the most recent candidate publication date as the publication date for the document.

### THE FIGURES

FIG. 1 is a flowchart of a prior art technique.

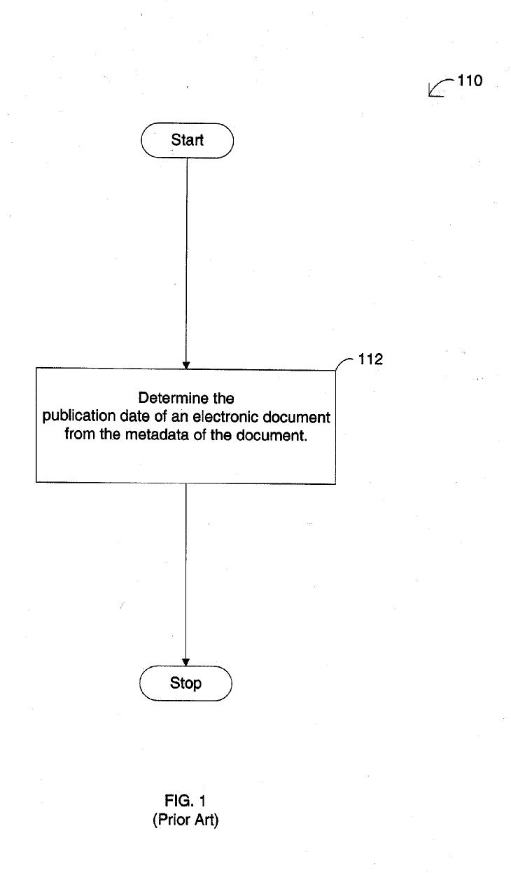

FIG. 2 is a flowchart in accordance with an exemplary embodiment of the present invention.

FIG. 3A is a flowchart of the recognizing step in accordance with an exemplary embodiment of the present invention.

FIG. 3B is a flowchart of the determining step in accordance with an exemplary embodiment of the present invention.

FIG. 3C is a flowchart of the recognizing step in accordance with an exemplary embodiment of the present invention.

FIG. 3D is a flowchart of the determining step in accordance with an exemplary embodiment of the present invention.

FIG. 3E is a flowchart of the recognizing step in accordance with an exemplary embodiment of the present invention.

FIG. 3F is a flowchart of the determining step in accordance with an exemplary embodiment of the present invention.

FIG. 3G is a flowchart of the recognizing step in accordance with an exemplary embodiment of the present invention.

FIG. 3H is a flowchart of the recognizing step in accordance with an exemplary embodiment of the present invention.

FIG. 4A is a flowchart of the resolving step in accordance with an exemplary embodiment of the present invention.

FIG. 4B is a flowchart of the resolving step in accordance with an exemplary embodiment of the present invention.

FIG. 4C is a flowchart of the resolving step in accordance with an exemplary embodiment of the present invention.

FIG. 4D is a flowchart of the resolving step in accordance with an exemplary embodiment of the present invention.

FIG. 4E is a flowchart of the resolving step in accordance with an exemplary embodiment of the present invention.

FIG. 5 is a flowchart of the validating step in accordance with an exemplary embodiment of the present invention.

FIG. 6A is a flowchart of the recognizing step in accordance with an exemplary embodiment of the present invention.

FIG. 6B is a flowchart of the determining step in accordance with an exemplary embodiment of the present invention.

FIG. 6C is a flowchart of the identifying step in accordance with an exemplary embodiment of the present invention.

FIG. 6D is a flowchart of the noting step in accordance with an exemplary embodiment of the present invention.

FIG. 7 is a flowchart in accordance with an exemplary embodiment of the present invention.

FIG. 8A is a flowchart of the recognizing step in accordance with an exemplary embodiment of the present invention.

FIG. 8B is a flowchart of the determining step in accordance with an exemplary embodiment of the present invention.

FIG. 8C is a flowchart of the recognizing step in accordance with an exemplary embodiment of the present invention.

FIG. 8D is a flowchart of the determining step in accordance with an exemplary embodiment of the present invention.

FIG. 8E is a flowchart of the recognizing step in accordance with an exemplary embodiment of the present invention.

FIG. 8F is a flowchart of the determining step in accordance with an exemplary embodiment of the present invention.

FIG. 8G is a flowchart of the recognizing step in accordance with an exemplary embodiment of the present invention.

FIG. 8H is a flowchart of the recognizing step in accordance with an exemplary embodiment of the present invention.

### DETAILED DESCRIPTION OF THE INVENTION

The present invention provides a method and system of assigning a publication date for at least one electronic document, where the publication date includes the year that the document was published, the month that the document was published, and the day that the document was published. In an exemplary embodiment, the method and system include (1) recognizing the publication date in the document by regular expression pattern matching, (2) if the publication date is ambiguous, resolving the ambiguous publication date, and (3) validating the publication date.

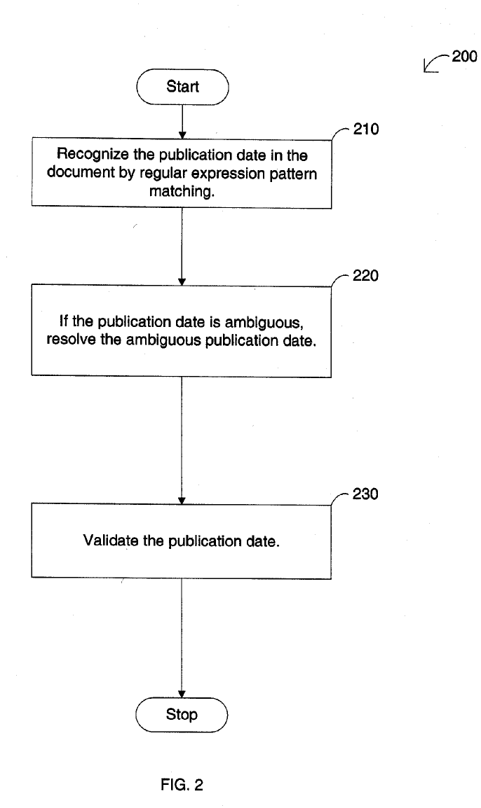

Referring to FIG. 2, in an exemplary embodiment, the present invention includes a step 210 of recognizing the publication date in the document by regular expression pattern matching, a step 220 of, if the publication date is ambiguous, resolving the ambiguous publication date, and a step 230 of validating the publication date.

Recognizing the Publication Date

Determining the Publication Date from the Document Identifier of the Document

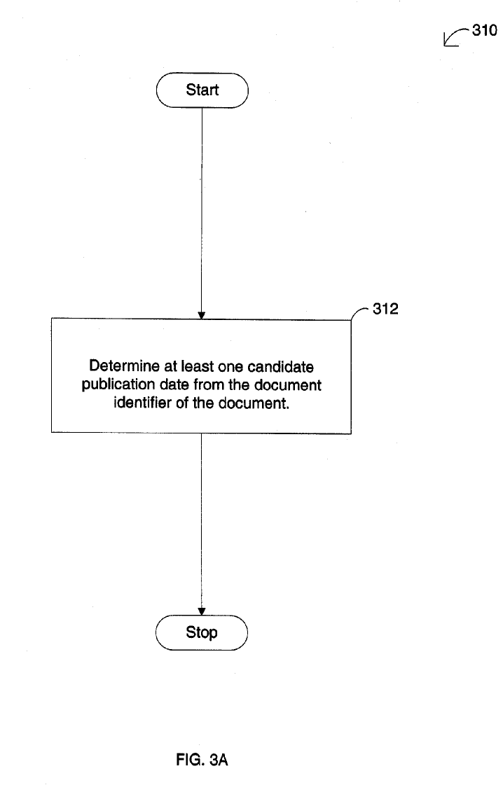

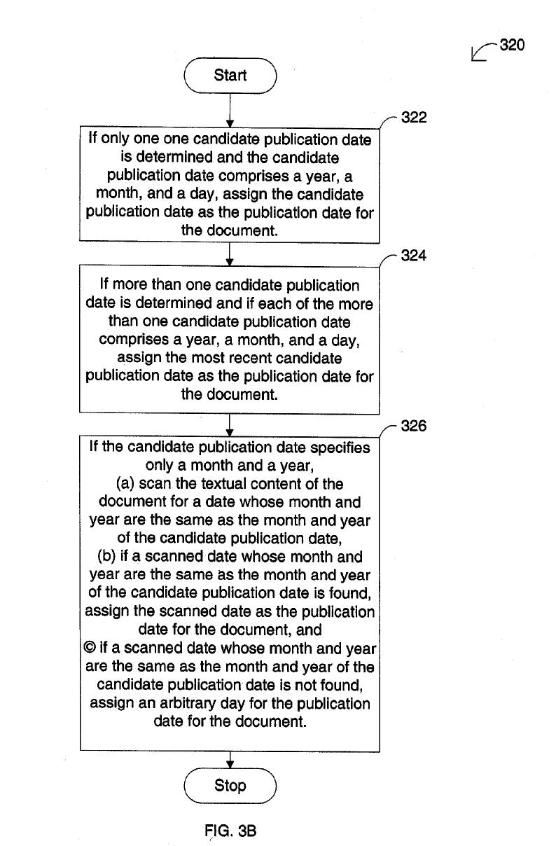

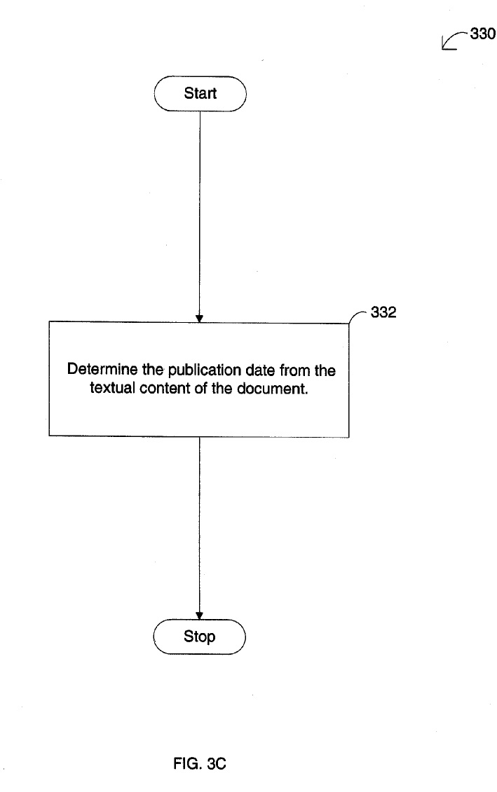

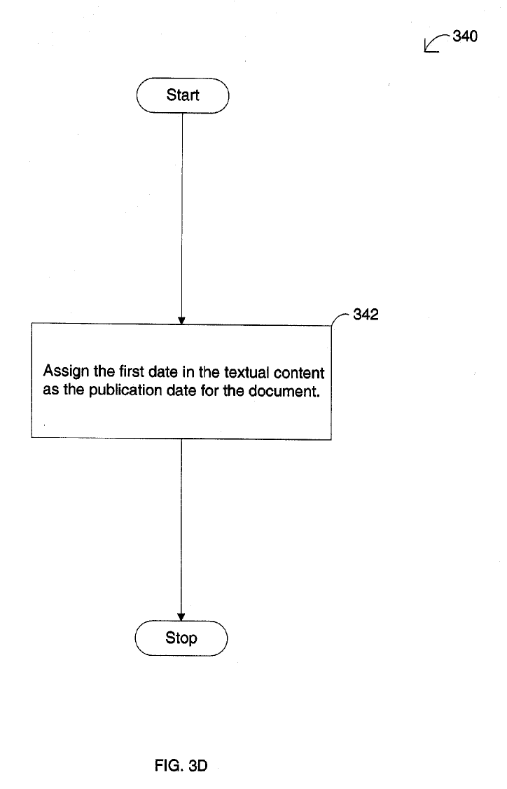

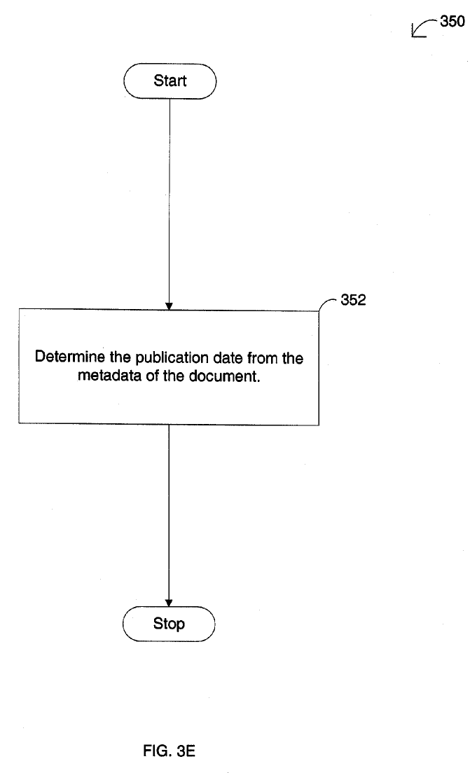

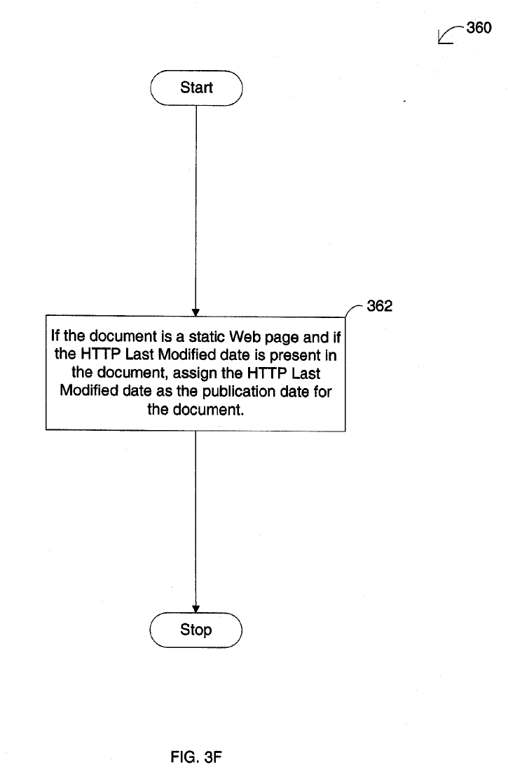

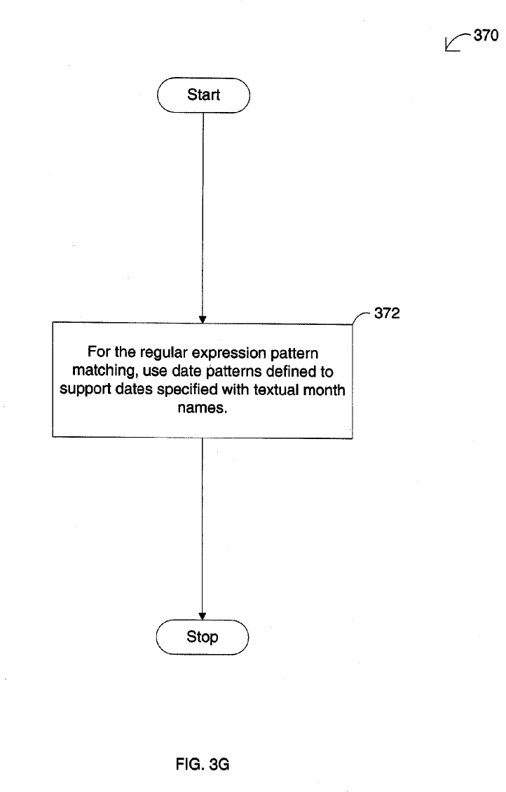

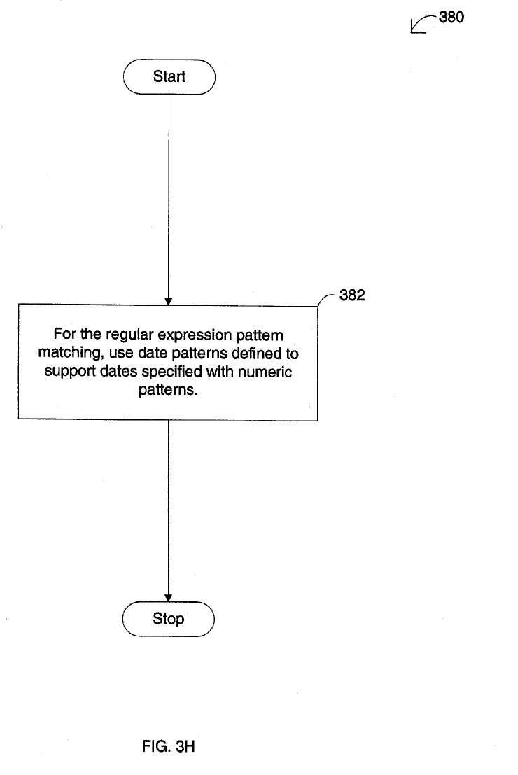

Referring next to FIG. 3A, in an exemplary embodiment, recognizing step 210 includes a step 312 of determining at least one candidate publication date from the document identifier of the document. In a specific embodiment, the document identifier is URI/URL of the document. Referring next to FIG. 3B, in an exemplary embodiment, determining step 312 includes a step 322 of, if only one candidate publication date is determined and the candidate publication date comprises a year, a month, and a day, assigning the candidate publication date as the publication date for the document, (e.g. If the text substring “12/15/2002” is found in the URL of the document, date of “December 15, 2002” would be assigned for the document.), a step 324 of, if more than one candidate publication date is determined and if each of the more than one candidate publication date comprises a year, a month, and a day, assigning the most recent candidate publication date as the publication date for the document, and a step 326 of, if the candidate publication date specifies only a month and a year, (a) scanning the textual content of the document for a date whose month and year are the same as the month and year of the candidate publication date, (b) if a scanned date whose month and year are the same as the month and year of the candidate publication date is found, assigning the scanned date as the publication date for the document, and (c) if a scanned date whose month and year are the same as the month and year of the candidate publication date is not found, assigning an arbitrary day for the publication date for the document.

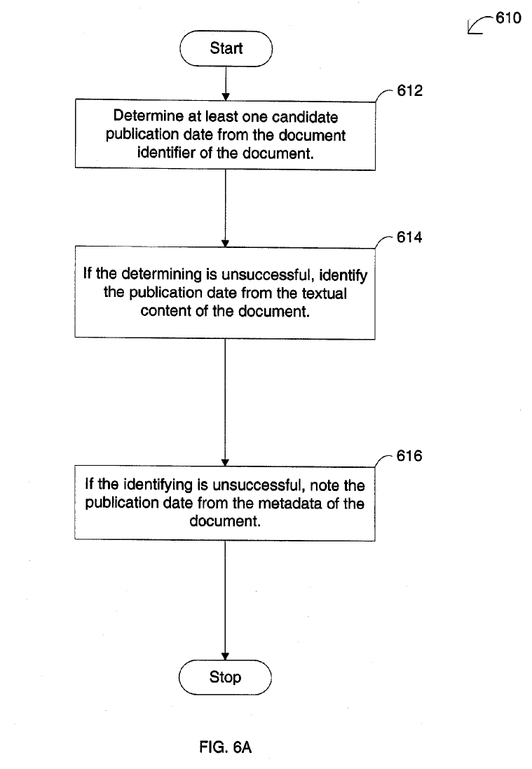

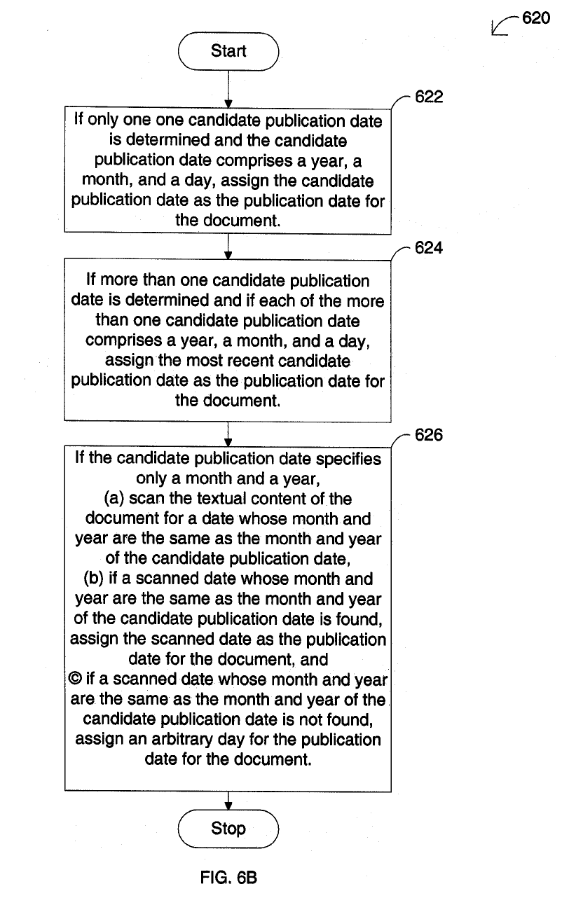

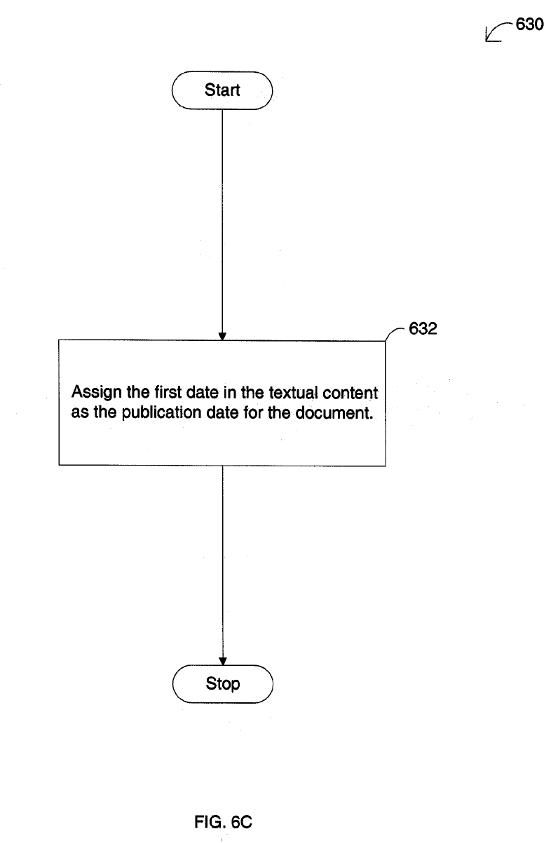

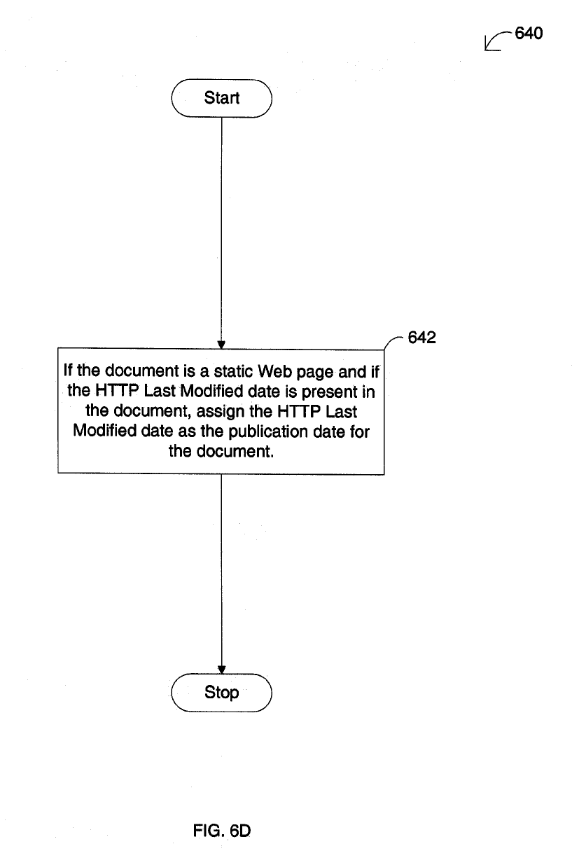

Referring next to FIG. 6A, in an exemplary embodiment, recognizing step 210 includes a step 612 of determining at least one candidate publication date from the document identifier of the document, a step 614 of, if the determining is unsuccessful, identifying the publication date from the textual content of the document, and a step 616 of, if the identifying is unsuccessful, noting the publication date from the metadata of the document. Referring next to FIG. 6B, in an exemplary embodiment, determining step 612 includes a step 622 of, if only one candidate publication date is determined and the candidate publication date comprises a year, a month, and a day, assigning the candidate publication date as the publication date for the document, a step 624 of, if more than one candidate publication date is determined and if each of the more than one candidate publication date comprises a year, a month, and a day, assigning the most recent candidate publication date as the publication date for the document, and a step 626 of, if the candidate publication date specifies only a month and a year, (a) scanning the textual content of the document for a date whose month and year are the same as the month and year of the candidate publication date, (b) if a scanned date whose month and year are the same as the month and year of the candidate publication date is found, assigning the scanned date as the publication date for the document, and (c) if a scanned date whose month and year are the same as the month and year of the candidate publication date is not found, assigning an arbitrary day for the publication date for the document.

Referring next to FIG. 6C, in an exemplary embodiment, identifying step 614 includes a step 632 of assigning the first date in the textual content as the publication date for the document. Referring next to FIG. 6D, in an exemplary embodiment, noting step 61 6 includes, a step 642 of, if the document is a static Web page and if the HTTP Last Modified date is present in the document, assigning the HTTP Last Modified date as the publication date for the document.

Determining the Publication Date from the Content of the Document

Referring next to FIG. 3C, in an exemplary embodiment, recognizing step 210 includes a step 332 of determining the publication date from the textual content of the document. Referring next to FIG. 3D, in an exemplary embodiment, determining step 332 includes a step 342 of assigning the first date in the textual content as the publication date for the document.

In an exemplary embodiment, anchor text used for annotating hyperlinks for Web pages (i.e. dates found in anchor text are dates found in the page that the links point to), and template or boilerplate text that occurs on all documents in a common node of a document hierarchy are not scanned for the publication date. Template text is found by existing algorithms such as that described in (1) Yi, B. Liu, X. Li, Eliminating Noisy Information in Web Pages for Data Mining, SIGKDD 03 and (2) Z. Bar-Jossef and S. Rajagopalan, Template Detection via Data Mining and Its Applications, WWW 2002.

Determining the Publication Date from the Metadata

Referring next to FIG. 3E, in an exemplary embodiment, recognizing step 210 includes a step 352 of determining the publication date from the metadata of the document. Referring next to FIG. 3F, in an exemplary embodiment, determining step 352 includes a step 362 of, if the document is a static Web page and if the HTTP Last Modified date is present in the document, assigning the HTTP Last Modified date as the publication date for the document. Other types of electronic documents have similar metadata that can similarly be used to assign the publication date.

Using Date Patterns

Referring next to FIG. 3G, in an exemplary embodiment, recognizing step 210 includes a step 372 of, for the regular expression pattern matching, using date patterns defined to support dates specified with textual month names. Exemplary date patterns defined to support dates specified with textual month names include the following:
(1) “January 15th 12:59:59 PST 1999”;
(2) “January 15th 12:59:59 1999”;
(3) “15th January 1999”;
(4) “January 15th 1999”;
(5) “1999 January 15th”;
(6) “January 1999”; and
(7) “1999 January”.

Referring next to FIG. 3H, in an exemplary embodiment, recognizing step 210 includes a step 382 of, for the regular expression pattern matching, using date patterns defined to support dates specified with numeric patterns. Exemplary date patterns defined to support dates specified with numeric patterns include the following:
(1) “01151999”;
(2) “01/5/1999”;
(3) “15/01/1999”;
(4) “1999/01/15”;
(5) “1999-01-15”; and
(6) “01.15.1999”.

In an exemplary embodiment, recognizing step 210 includes (a) detecting abbreviated and full names of month names, (b) detecting dates in multiple languages by use of a static vocabulary of month names, (c) detecting the day of the publication date in either cardinal form (e.g. 1, 2, 3) or ordinal form (e.g. 1st, 2nd, 3rd). In an exemplary embodiment, if the publication date includes only a month and year, then a fixed day of month is assigned (e.g. the first of the month).

In an exemplary embodiment, a numeric pattern of the form nnnnnn (or nnnnnnnn) is considered as a candidate publication date only if it can be divided into patterns of dd mm yy (or ddmmyyyy, mmddyy or mmddyyyy) where dd is less than or equal to 31, mm is less than or equal to 12, and yy (yyyy) is up to the current year.

Resolving Ambiguous Dates

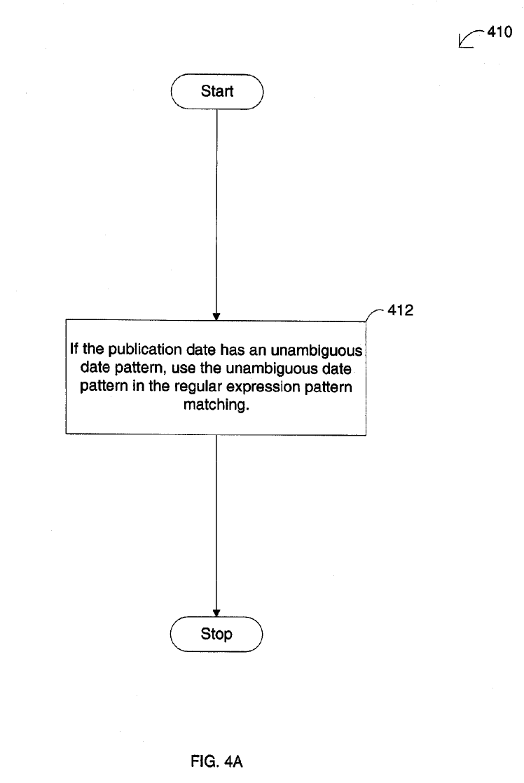

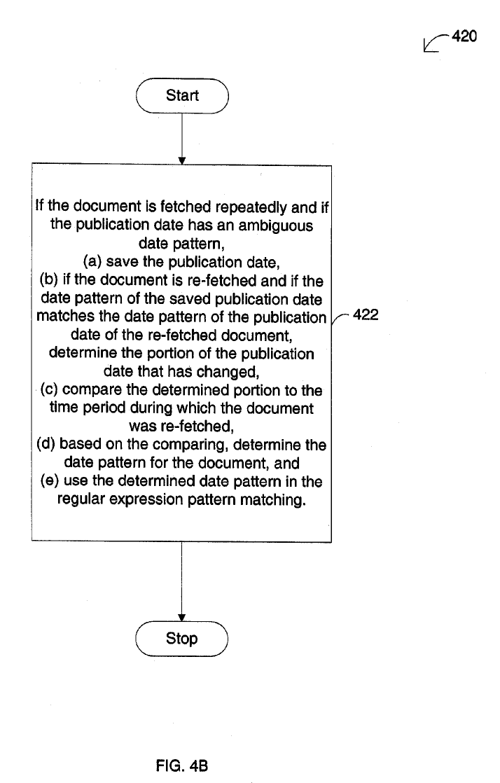

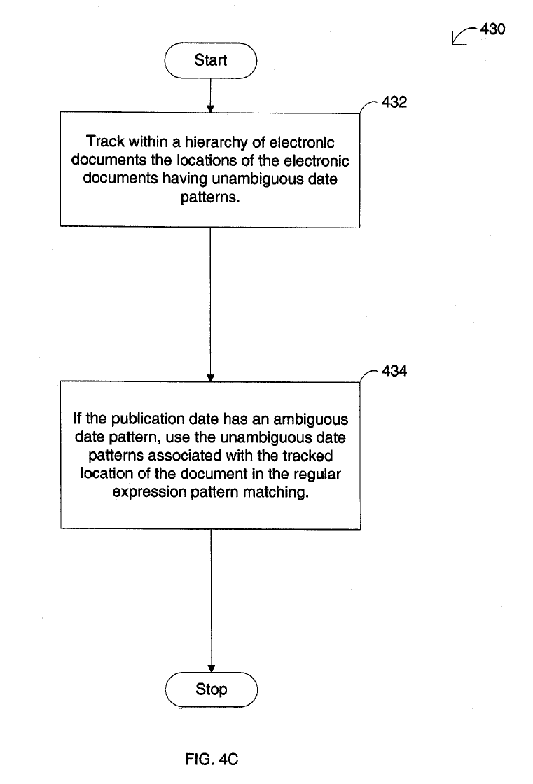

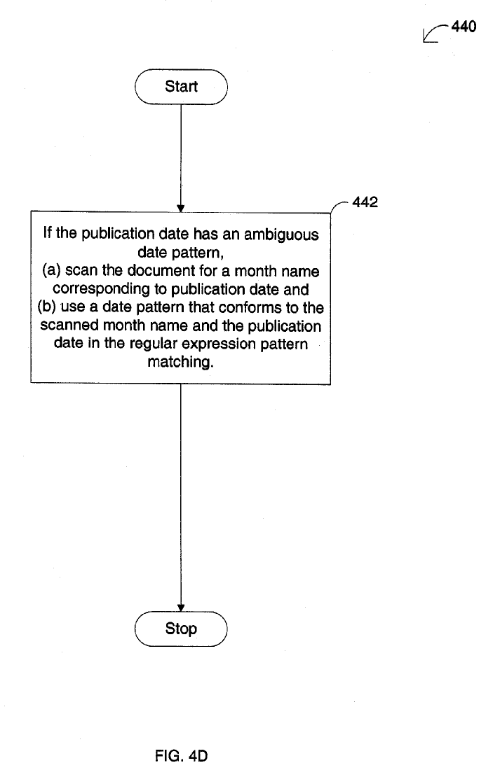

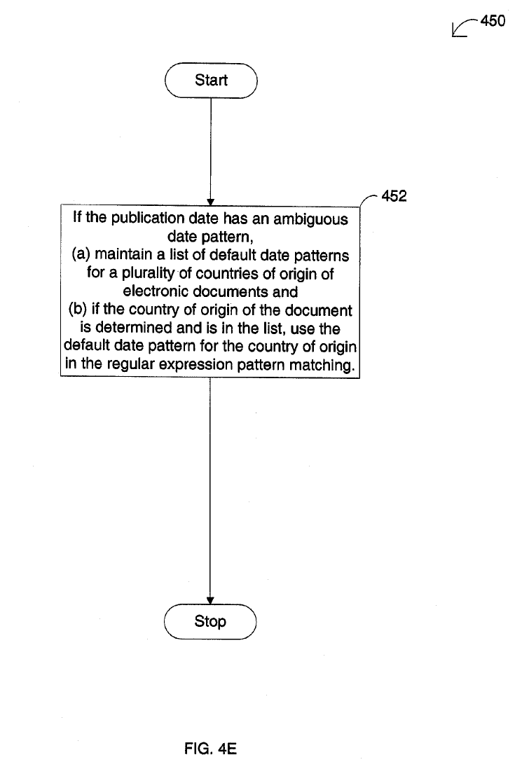

Referring next to FIG. 4A, in an exemplary embodiment, resolving step 220 includes a step 412 of, if the publication date has an unambiguous date pattern, using the unambiguous date pattern in the regular expression pattern matching. For example, if the first date found in the document is “07/01/2004,” the date can be either July 1 or Jan 7 of 2004. If in the same document, a second date of “06/15/2004” is found, then the date pattern used for the entire document is assumed to be mm/dd/yyyy, and the assignment for the publication date becomes July 1, 2004.

Referring next to FIG. 4B, in an exemplary embodiment, resolving step 220 includes a step 422 of, if the document is fetched repeatedly and if the publication date has an ambiguous date pattern, (a) saving the publication date, (b) if the document is re-fetched and if the date pattern of the saved publication date matches the date pattern of the publication date of the re-fetched document, determining the portion of the publication date that has changed, (c) comparing the determined portion to the time period during which the document was re-fetched, (d) based on the comparing, determining the date pattern for the document, and (e) using the determined date pattern in the regular expression pattern matching. For example, if the date pattern in the document is “02/04/04” and the date pattern in the document when the document is re-fetched one week later is “02/11/04”, the date pattern of mm/dd/yy is used. In addition, for example, if the date pattern in the document when the document is re-fetched one week later is “09/04/04”, the date pattern of dd/mm/yy is used.

Referring next to FIG. 4C, in an exemplary embodiment, resolving step 220 includes a step 432 of tracking within a hierarchy of electronic documents the locations of the electronic documents having unambiguous date patterns and a step 434 of, if the publication date has an ambiguous date pattern, using the unambiguous date patterns associated with the tracked location of the document in the regular expression pattern matching. In an exemplary embodiment, tracking step 432 includes maintaining a list of nodes and date patterns in the hierarchy. For example, for the Web, the nodes may correspond to sites and site/directory combinations. An entry in the list may be one of the following:

(1) “www.name.com count of mm/dd/yy count of dd/mm/yy”

or

(2) “www.name.com/directory count of mm/dd/yy count of dd/mm/yy”.

In an exemplary embodiment, the counts are counts of unambiguous dates identified.

In addition, tracking step 432 includes collapsing a directory in the hierarchy upward when one date pattern is more than a t % majority in all subdirectories in the directory. For example, tracking step 432 would collapse

“www.name.com/topdirectory/directory1” and

“www.name.com/topdirectory/directory2”

if dd/mm/yy is an 80% majority in both directory1 and directory2. When an ambiguous date is identified, if it belongs to a node with a t % majority format, interpret the date according to the unambiguous date pattern.

Referring next to FIG. 4D, in an exemplary embodiment, resolving step 220 includes a step 442 of, if the publication date has an ambiguous date pattern, (a) scanning the document for a month name corresponding to publication date and (b) using a date pattern that conforms to the scanned month name and the publication date in the regular expression pattern matching. For example, if the date “07/04/04” is found, if a reference to July 2004 is found, and if no reference to April 2004 is found, resolving step 220 resolves the date to be in the date pattern “mm/dd/yy”.

Referring next to FIG. 4E, in an exemplary embodiment, resolving step 220 includes a step 452 of, if the publication date has an ambiguous date pattern, (a) maintaining a list of default date patterns for a plurality of countries of origin of electronic documents and (b) if the country of origin of the document is determined and is in the list, using the default date pattern for the country of origin in the regular expression pattern matching. For example, if the document originates in the United Kingdom, the date pattern of “dd/mm/yy” is used.

Validating the Publication Date

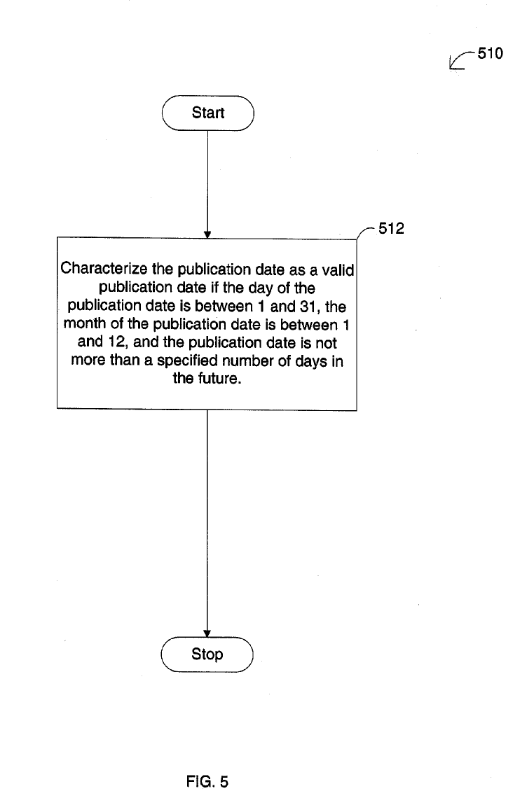

Referring next to FIG. 5, in an exemplary embodiment, validating step 230 includes a step 512 of characterizing the publication date as a valid publication date if the day of the publication date is between 1 and 31, the month of the publication date is between 1 and 12, and the publication date is not more than a specified number of days in the future. In an exemplary embodiment, the beginning of the specified number of days is the HTTP Last Modified date of the document. In an exemplary embodiment, the beginning of the specified number of days is the date that the document was obtained. In an exemplary embodiment, the specified number of days ranges from 1 day to 10 days.

Publication Date Including a Year and Month

The present invention also provides a method and system of assigning a publication date for at least one electronic document, where the publication date includes the year that the document was published and the month that the document was published. In an exemplary embodiment, the method and system include (1) recognizing the publication date in the document by regular expression pattern matching, (2) if the publication date is ambiguous, resolving the ambiguous publication date, and (3) validating the publication date.

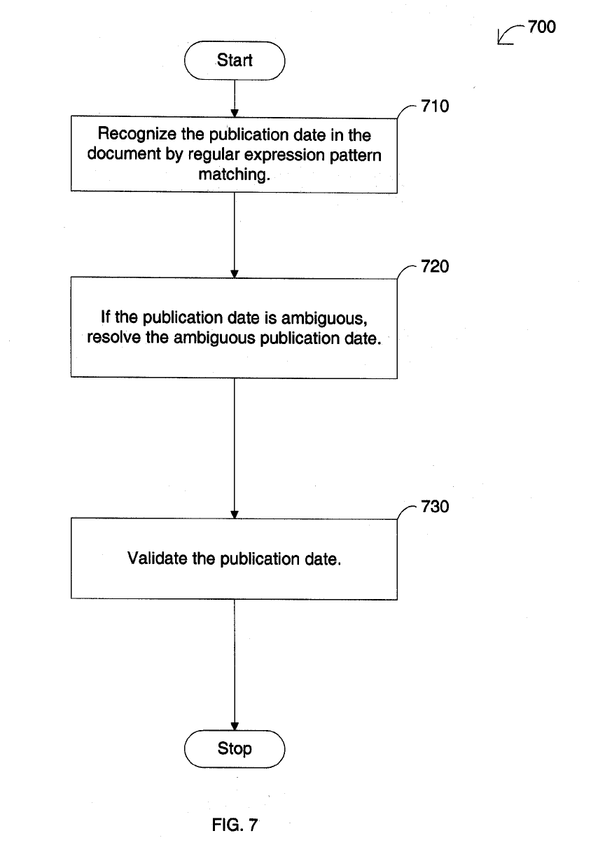

Referring to FIG. 7, in an exemplary embodiment, the present invention includes a step 710 of recognizing the publication date in the document by regular expression pattern matching, a step 720 of, if the publication date is ambiguous, resolving the ambiguous publication date, and a step 730 of validating the publication date.

Recognizing the Publication Date

Determining the Publication Date from the Document Identifier of the Document

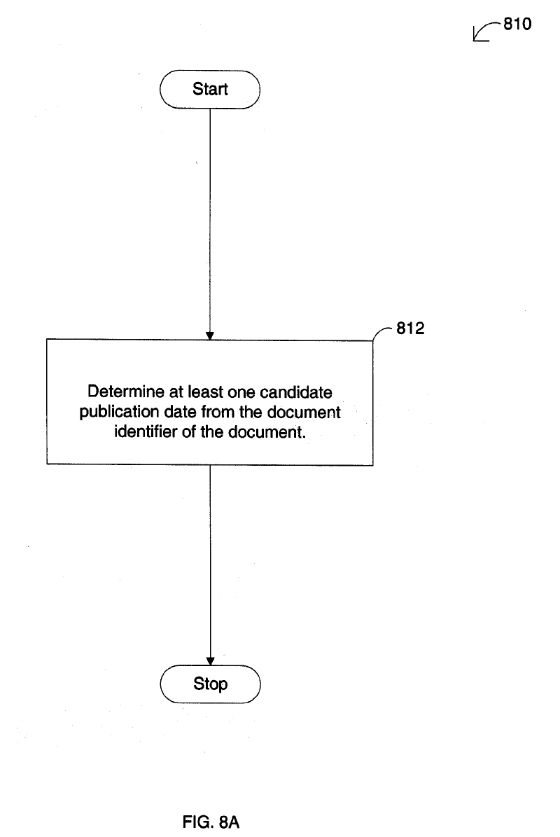

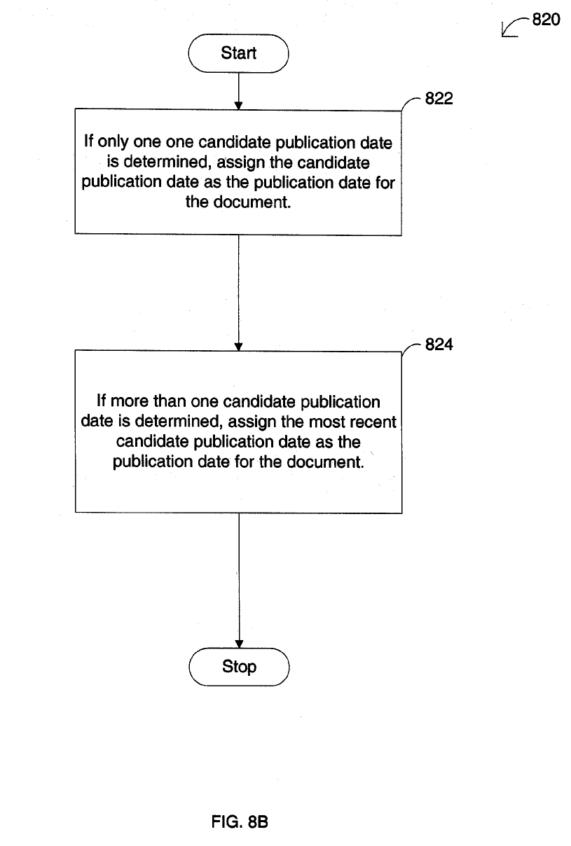

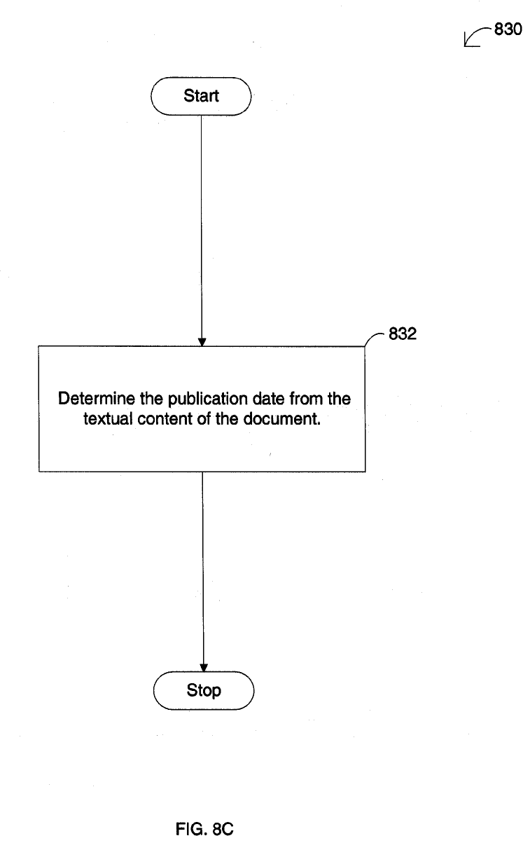

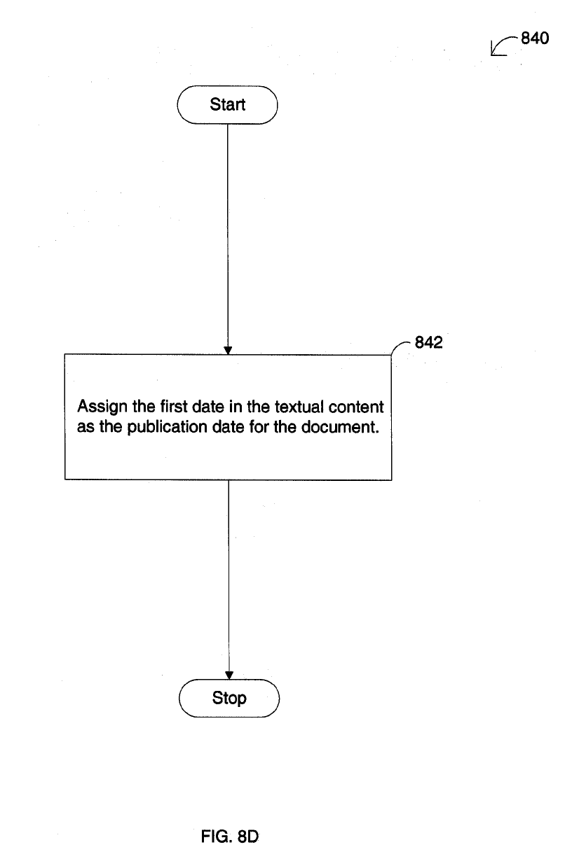

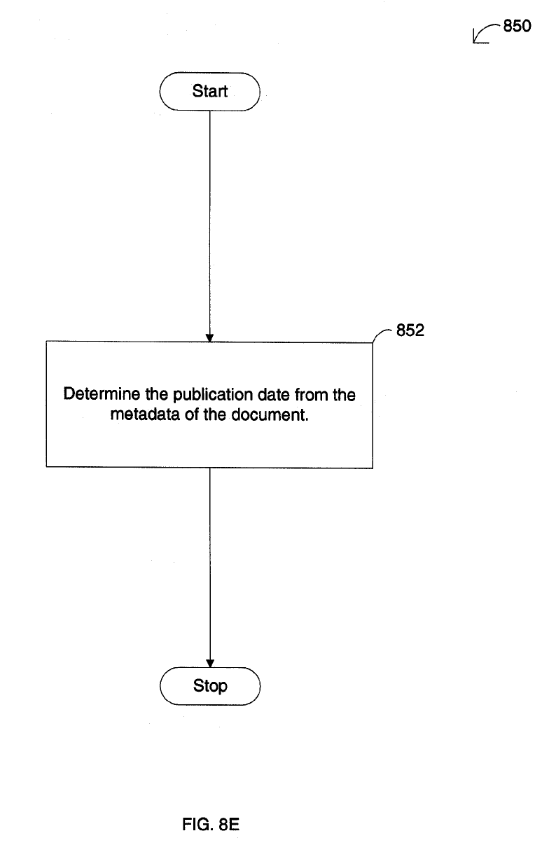

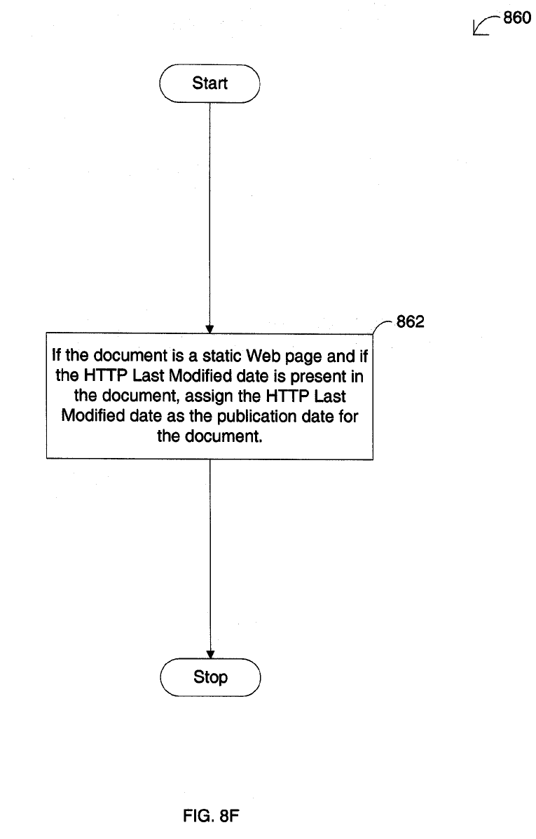

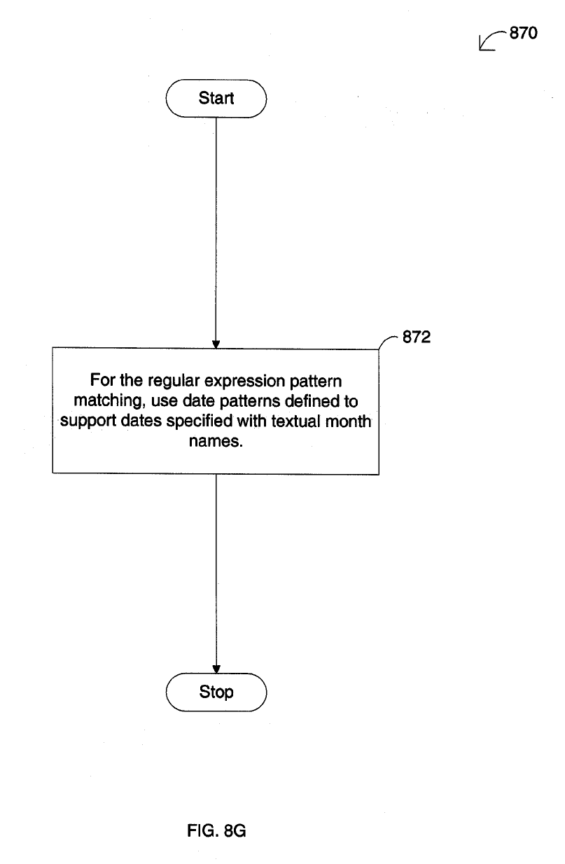

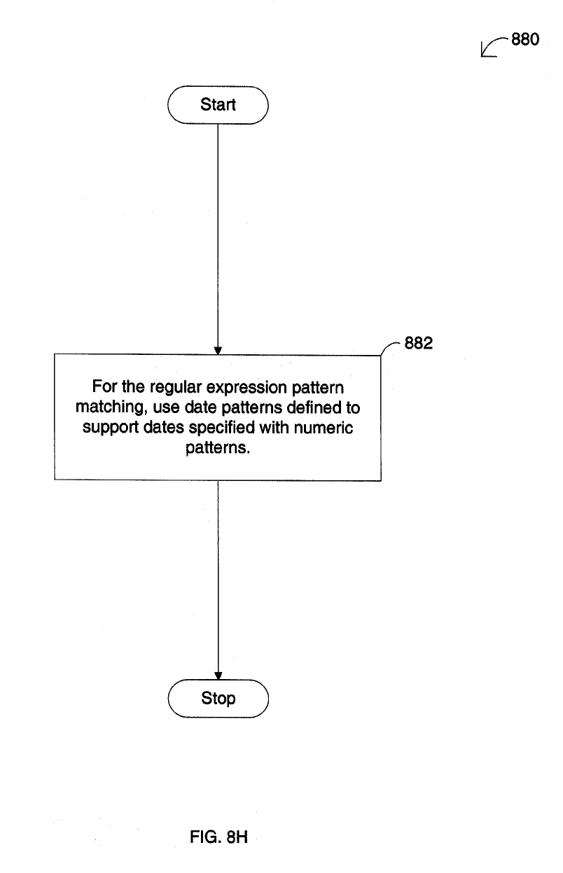

Referring next to FIG. 8A, in an exemplary embodiment, recognizing step 710 includes a step 812 of determining at least one candidate publication date from the document identifier of the document. In a specific embodiment, the document identifier is URI/URL of the document. Referring next to FIG. 8B, in an exemplary embodiment, determining step 812 includes a step 822 of, if only one candidate publication date is determined, assigning the candidate publication date as the publication date for the document and (2) a step 824 of, if more than one candidate publication date is determined, assigning the most recent candidate publication date as the publication date for the document.

Determining the Publication Date from the Content of the Document

Referring next to FIG. 8C, in an exemplary embodiment, recognizing step 710 includes a step 832 of determining the publication date from the textual content of the document. Referring next to FIG. 8D, in an exemplary embodiment, determining step 832 includes a step 842 of assigning the first date in the textual content as the publication date for the document.

Determining the Publication Date from the Metadata

Referring next to FIG. 8E, in an exemplary embodiment, recognizing step 710 includes a step 852 of determining the publication date from the metadata of the document. Referring next to FIG. 8F, in an exemplary embodiment, determining step 852 includes a step 862 of, if the document is a static Web page and if the HTTP Last Modified date is present in the document, assigning the HTTP Last Modified date as the publication date for the document. Other types of electronic documents have similar metadata that can similarly be used to assign the publication date.

Using Date Patterns

Referring next to FIG. 8G, in an exemplary embodiment, recognizing step 710 includes a step 872 of, for the regular expression pattern matching, using date patterns defined to support dates specified with textual month names. Referring next to FIG. 8H, in an exemplary embodiment, recognizing step 810 includes a step 882 of, for the regular expression pattern matching, using date patterns defined to support dates specified with numeric patterns.

In an exemplary embodiment, recognizing step 710 includes (a) detecting abbreviated and full names of month names, (b) detecting dates in multiple languages by use of a static vocabulary of month names, (c) detecting the day of the publication date in either cardinal form (e.g. 1, 2, 3) or ordinal form (e.g. 1st, 2nd, 3rd). In an exemplary embodiment, if the publication date includes only a month and year, then a fixed day of month is assigned (e.g. the first of the month).

Conclusion

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

What is claimed is:

1. A method of assigning a publication date for at least one electronic document, wherein the publication date comprises the year that the document was published, the month that the document was published, and the day that the document was published, the method comprising:
recognizing the publication date in the document by regular expression pattern matching;
if the publication date is ambiguous, resolving the ambiguous publication date; and
validating the publication date.

2. The method of claim 1 wherein the recognizing comprises determining at least one candidate publication date from the document identifier of the document.

3. The method of claim 2 wherein the determining comprises:
if only one candidate publication date is determined and the candidate publication date comprises a year, a month, and a day, assigning the candidate publication date as the publication date for the document;
if more than one candidate publication date is determined and if each of the more than one candidate publication date comprises a year, a month, and a day, assigning the most recent candidate publication date as the publication date for the document; and
if the candidate publication date specifies only a month and a year,
scanning the textual content of the document for a date whose month and year are the same as the month and year of the candidate publication date,
if a scanned date whose month and year are the same as the month and year of the candidate publication date is found, assigning the scanned date as the publication date for the document, and
if a scanned date whose month and year are the same as the month and year of the candidate publication date is not found, assigning an arbitrary day for the publication date for the document.

4. The method of claim 1 wherein the recognizing comprises determining the publication date from the textual content of the document.

5. The method of claim 4 wherein the determining comprises assigning the first date in the textual content as the publication date for the document.

6. The method of claim 1 wherein the recognizing comprises determining the publication date from the metadata of the document.

7. The method of claim 6 wherein the determining comprises, if the document is a static Web page and if the HTTP Last Modified date is present in the document, assigning the HTTP Last Modified date as the publication date for the document.

8. The method of claim 1 wherein the recognizing comprises, for the regular expression pattern matching, using date patterns defined to support dates specified with textual month names.

9. The method of claim 1 wherein the recognizing comprises, for the regular expression pattern matching, using date patterns defined to support dates specified with numeric patterns.

10. The method of claim 1 wherein the resolving comprises, if the publication date has an unambiguous date pattern, using the unambiguous date pattern in the regular expression pattern matching.

11. The method of claim 1 wherein the resolving comprises, if the document is fetched repeatedly and if the publication date has an ambiguous date pattern,
saving the publication date;
if the document is re-fetched and if the date pattern of the saved publication date matches the date pattern of the publication date of the re-fetched document, determining the portion of the publication date that has changed;
comparing the determined portion to the time period during which the document was re-fetched;
based on the comparing, determining the date pattern for the document; and
using the determined date pattern in the regular expression pattern matching.

12. The method of claim 1 wherein the resolving comprises:
tracking within a hierarchy of electronic documents the locations of the electronic documents having unambiguous date patterns; and
if the publication date has an ambiguous date pattern, using the unambiguous date pattern associated with the tracked location of the document in the regular expression pattern matching.

13. The method of claim 1 wherein the resolving comprises, if the publication date has an ambiguous date pattern,
scanning the document for a month name corresponding to publication date; and
using a date pattern that conforms to the scanned month name and the publication date in the regular expression pattern matching.

14. The method of claim 1 wherein the resolving comprises, if the publication date has an ambiguous date pattern,
maintaining a list of default date patterns for a plurality of countries of origin of electronic documents; and
if the country of origin of the document is determined and is in the list, using the default date pattern for the country of origin in the regular expression pattern matching.

15. The method of claim 1 wherein the validating comprises characterizing the publication date as a valid publication date if
the day of the publication date is between 1 and 31,
the month of the publication date is between 1 and 12, and
the publication date is not more than a specified number of days in the future.

16. The method of claim 15 wherein the beginning of the specified number of days is the HTTP Last Modified date of the document.

17. The method of claim 15 wherein the beginning of the specified number of days is the date that the document was obtained.

18. The method of claim 15 wherein the specified number of days ranges from 1 day to 10 days.

19. The method of claim 1 wherein the recognizing comprises:
determining at least one candidate publication date from the document identifier of the document;
if the determining is unsuccessful, identifying the publication date from the textual content of the document; and
if the identifying is unsuccessful, noting the publication date from the metadata of the document.

20. The method of claim 19 wherein the determining comprises:
if only one candidate publication date is determined and the candidate publication date comprises a year, a month, and a day, assigning the candidate publication date as the publication date for the document;
if more than one candidate publication date is determined and if each of the more than one candidate publication date comprises a year, a month, and a day, assigning the most recent candidate publication date as the publication date for the document; and
if the candidate publication date specifies only a month and a year,
scanning the textual content of the document for a date whose month and year are the same as the month and year of the candidate publication date,
if a scanned date whose month and year are the same as the month and year of the candidate publication date is found, assigning the scanned date as the publication date for the document, and
if a scanned date whose month and year are the same as the month and year of the candidate publication date is not found, assigning an arbitrary day for the publication date for the document.

21. The method of claim 19 wherein the identifying comprises assigning the first date in the textual content as the publication date for the document.

22. The method of claim 19 wherein the noting comprises, if the document is a static Web page and if the HTTP Last Modified date is present in the document, assigning the HTTP Last Modified date as the publication date for the document.

23. The method of claim 19 wherein the recognizing comprises, for the regular expression pattern matching, using date patterns defined to support dates specified with textual month names.

24. The method of claim 19 wherein the recognizing comprises, for the regular expression pattern matching, using date patterns defined to support dates specified with numeric patterns.

25. A method of assigning a publication date for at least one electronic document, wherein the publication date comprises the year that the document was published and the month that the document was published, the method comprising:
recognizing the publication date in the document by regular expression pattern matching;
if the publication date is ambiguous, resolving the ambiguous publication date; and
validating the publication date.

26. The method of claim 25 wherein the recognizing comprises determining at least one candidate publication date from the document identifier of the document.

27. The method of claim 26 wherein the determining comprises:
if only one candidate publication date is determined, assigning the candidate publication date as the publication date for the document;
if more than one candidate publication date is determined, assigning the most recent candidate publication date as the publication date for the document.

28. The method of claim 25 wherein the recognizing comprises determining the publication date from the textual content of the document.

29. The method of claim 28 wherein the determining comprises assigning the first date in the textual content as the publication date for the document.

30. The method of claim 25 wherein the recognizing comprises determining the publication date from the metadata of the document.

31. The method of claim 30 wherein the determining comprises, if the document is a static Web page and if the HTTP Last Modified date is present in the document, assigning the HTTP Last Modified date as the publication date for the document.

32. The method of claim 25 wherein the recognizing comprises, for the regular expression pattern matching, using date patterns defined to support dates specified with textual month names.

33. The method of claim 25 wherein the recognizing comprises, for the regular expression pattern matching, using date patterns defined to support dates specified with numeric patterns.

34. A system of assigning a publication date for at least one electronic document, wherein the publication date comprises the year that the document was published, the month that the document was published, and the day that the document was published, the system comprising:
a recognizing module configured to recognize the publication date in the document by regular expression pattern matching;
a resolving module configured to, if the publication date is ambiguous, resolve the ambiguous publication date; and
a validating module configured to validate the publication date.

35. A computer program product usable with a programmable computer having readable program code embodied therein of assigning a publication date for at least one electronic document, wherein the publication date comprises the year that the document was published, the month that the document was published, and the day that the document was published, the computer program product comprising:
computer readable code for recognizing the publication date in the document by regular expression pattern matching;
computer readable code for if the publication date is ambiguous, resolving the ambiguous publication date; and
computer readable code for validating the publication date.
